(19) United States
(12) Patent Application Publication
(10) Pub. No.: US 2017/0211599 A1
(43) Pub. Date: Jul. 27, 2017

(54) HYDRAULIC DRIVE UNIT AND METHOD OF OPERATING

(71) Applicant: ENGEL AUSTRIA GmbH, Schwertberg (AT)

(72) Inventors: Anton LOHNECKER, Ertl (AT); Helmut STEINPARZER, Steyr (AT); Herbert ZEIDLHOFER, Haag (AT)

(21) Appl. No.: 15/415,140

(22) Filed: Jan. 25, 2017

(30) Foreign Application Priority Data
Jan. 26, 2016 (AT) A 38/2016

(51) Int. Cl. F15B 15/28; F15B 9/03

(52) U.S. Cl. CPC F15B 15/2884; F15B 9/03; F15B 2211/6336; F15B 2211/6306

(57) ABSTRACT

A hydraulic drive unit for a shaping machine comprising a pump driven by a motor, a closed-loop or open-loop control unit for closed-loop and/or open-loop control of the drive unit to a reference operating point of the drive unit, and a memory connected to the closed-loop or open-loop control unit, wherein a relationship between a parameter characteristic of a sound directly or indirectly caused by the drive unit and a data set representing various operating points of the drive unit is stored in the memory and the closed-loop or open-loop control unit is adapted to select the reference operating point on the basis of the relationship.

The present invention concerns a hydraulic drive unit for a shaping machine having the features of the classifying portion of claim 1 and a method of operating a hydraulic drive unit for a shaping machine.

Hydraulic drives are more and more frequently driven with rotary speed-regulated motors primarily for reasons related to energy in order in the stopped condition not to suffer any unnecessary no-load losses, but also to operate the drive system with an improved level of efficiency in the part-load range. In that respect it is both possible to drive fixed displacement pumps and to adjust the required delivery amounts purely by way of the motor speed, and also to combine the variable-speed motors with variable displacement pumps and therefore to have in practice two degrees of freedom (motor speed, pump adjustment) when selecting the desired delivery amount.

In the arrangement involving a regulating pump therefore the external delivery amount is formed by the product of motor speed and pump displacement (also referred to as pump pivot angle). This also means however that any delivery volume which is under the maximum possible delivery volume of the system can then be achieved with different operating points.

An example: 50% external delivery volume could be implemented with the following operating states:

50% pump adjustment and 100% speed,

100% pump adjustment and 50% speed, and

all graduations therebetween.

It is known from AT 11681 U1 or DE 10 2009 018 071 A1 to use that situation in optimizing the degree of efficiency of the hydraulic drive. The noise emission of the hydraulic drive or a shaping machine together with the hydraulic drive was not taken into consideration in that case.

Therefore the object of the invention is to provide a hydraulic drive unit and a method of operating a hydraulic drive unit, wherein quieter operation than in the state of the art is possible.

In regard to the hydraulic drive unit this is achieved by the features of claim 1. In regard to the method this is achieved by the features of claim 13.

It is provided in that respect that a relationship is to be provided between a parameter characteristic of a sound directly or indirectly caused by the drive unit and a data set representing various operating points of the drive unit and based on the relationship an operating point of the drive unit is to be selected as a reference operating point for closed-loop and/or open-loop control of the drive units.

Investigations by the applicant have shown that the commonly assumed relationship, that a pump motor would be automatically quieter at a low speed, does not hold true. The invention makes use of that surprising realization to permit quieter operation.

That optimization of noise emission can be used instead of or in combination with efficiency optimization as described hereinbefore.

The invention can be used in shaping machines. Shaping machines are for example injection molding machines, transfer molding machines, presses or the like.

Advantageous embodiments of the invention are defined in the appendant claims. It can be provided that the motor is subjected to closed-loop or open-loop control in respect of rotary speed.

The parameter which is characteristic of a sound directly or indirectly caused by the drive unit can be a sound parameter like for example a sound pressure. In that way the relationship can be intuitively reproduced for operators.

The characteristic parameter however can also be a measure in respect of vibration of apparatus parts, a measurement in respect of pressure pulsations in hydraulic lines or inputs of a operator on the basis of volume perception. Combinations of those parameters can naturally also be used.

The operating points of the data set may include at least one pump speed and/or pump displacement.

It can be provided that given operating points of the data set are marked as unwanted and the closed-loop or open-loop control unit is adapted not to use ranges of unwanted operating points as a reference operating point or to alter the reference operating point if same is in a range of unwanted operating points.

On the basis of measurements and empirical values, it would be possible in the various operating states to ascertain the rotary speeds which are most detrimental in terms of sound level, and to avoid them in future in actuation of the motor/pump unit. In other words, on the basis of previous measurements, unwanted speed ranges are established, wherein the desired external delivery volume is achieved by a modified pump setting in a desired speed range.

It can also be provided that the operating point is altered if the currently prevailing operating point falls in an unwanted range.

In that respect moreover matters are not limited to unwanted speed ranges. It is also possible to use unwanted pump displacement ranges and naturally combinations. In other words, it is possible to mark quite special pairs of values consisting of speed and pump displacement, as unwanted ranges.

It can also be provided that certain operating of the data set are marked as desired and the closed-loop or open-loop control unit is adapted to select reference operating points from ranges of desired operating points.

This makes it possible not only to avoid operating points involving particularly high levels of noise emission, but also to deliberately actuate operating points involving particularly quiet operation. Ranges of desired operating point, similarly to the unwanted operating points, can be speed ranges, pump displacement ranges and combinations thereof.

The relationship provided can either be stored in advance (for example in manufacture of the hydraulic drive unit or the shaping machine), or, for example on the basis of the measurement values of a measuring device for measuring the characteristic parameter, adaptation thereof can be implemented in given intervals or continuously, in particular during operation.

A measuring device for measurement of the characteristic parameter however can also be used for closed-loop or open-loop control, in which case the measurement values of the measuring device serve as a feedback parameter.

In that respect it may also be advantageous to be able to measure the characteristic parameter not only at any desired moment in time but also in location-variable fashion (for example in the proximity of a workplace). It would then be possible to start a calibration operation in which the motor speed (for example in the pressure regulating mode) is slowly increased (see also the Figure). It would then be possible for example to ascertain unwanted ranges and/or freshly establish same.

However constant or continuous measurement of the characteristic parameter may also offer advantages. A fixedly (or also moveably) installed and permanent measurement device in an installation could not only ascertain any interference fields in a standardized and limited state but also assess the actual installation cycle or also individual, freely selectable sequences and feed same to an optimization process.

An example in that respect:

Increased levels of noise emission occur in the metering operation of an injection molding machine. The measuring device assesses the actual state only during the sequence “metering” and the installation automatically implements that sequence in the next cycles in different operating points (for example different motor speeds) and ascertains the state which is best in terms of noise which is then used in future.

The measuring device for measuring the characteristic parameter can be of different configurations. It is also possible to conclude about increased levels of noise emission by evaluation of other sensors present.

Examples of possible measuring devices would be:

a) direct sound pressure level measurement (complicated and expensive but the most effective),

b) vibration measurements on installation parts like frame structure, flat covers, protective grids and so forth (relatively inexpensive sensors, could be deliberately positioned as possible interference resonance bodies),

c) pressure pulsation measurement in the pressure lines (by selection of operating points with lower pressure pulsation other parts of the installation are also less excited; advantage: pressure sensors which are present in any case in the hydraulic installation could be evaluated), and

d) perception of the installation user or operator (the operator could simply select the operating mode which he perceives as being most pleasant).

Methods a), b) and d) could be used both at fixedly defined locations in the installations and also in completely location-variable fashion. In other words, it would be possible to quite deliberately position variable sensors at selected locations in order to optimize the noise emission precisely there (for example sound measurement or subjective assessment at the workplace; vibration measurement at the glass window to adjoining office or the like).

The various methods for implementation of the invention (prohibited ranges, continuous measurement and so forth) and the various measurement methods can be freely combined. That is clearly shown in the following Table.

| | | b | c | d |
|---|---|---|---|---|
| | a (sound) | (vibration) | (pressure pulse) | (perception) |
| Unwanted ranges | x | x | X | X |
| Unwanted ranges | x | x | X | X |
| with calibration | | | | |
| operation | | | | |
| Continuous | x | x | X | X |
| measurement | | | | |

In all the methods a selection can also be made between peak value optimization or mean value optimization.

It can further be provided that the closed-loop or open-loop control unit, in terms of selection of the reference operating point, takes account of a minimum delivery capacity, a minimum volume flow to be delivered (also referred to as the external delivery amount) and/or a minimum pressure to be maintained.

In addition it can be provided that the closed-loop or open-loop control unit, in respect of selection of the reference operating point, takes account of effectiveness in terms of energy, in particular efficiency of the hydraulic drive unit. Similarly to selecting the operating point on the basis of the parameter which is characteristic of the sound caused by the drive unit, it is also possible, in regard to additional selection on the basis of energy effectiveness, to have recourse to measurement values of measuring devices for measuring for example levels of performance. In addition, it is similarly possible to provide for determining desired and/or unwanted efficiency ranges in relation to energy effectiveness.

In a particularly preferred embodiment an operator can select whether the choice of the operating point is to be prioritized on the basis of the characteristic parameter or on the basis of energy effectiveness. If for example the former is the case, then firstly desired ranges are established. Within those desired ranges (desired on the basis of the characteristic parameter) the operating point can then be precisely set on the basis of energy effectiveness. If the operator sets prioritization to energy effectiveness the method can be similarly carried out, in which case the desired effectiveness ranges take over the part of the desired ranges.

Especially in the case of longer constant installation sequences (like for example in an injection molding machine the holding-pressure phase or metering), further “varieties” arise, as here this can generally involve noise emissions which are monotonic and precisely for that reason troublesome.

Instead of a monotonic noise which remains the same, with a frequency which remains the same, it would be possible to operate “sound models” which are more pleasant to the ear and which can be freely selected by the operator. That could be simple oscillations or waves, but also (simple) melodies.

There would further be the possibility, in relation to longer constant sequences, of using the change in rotary speed or sound to acoustically indicate the end of the sequence.

A function as an error or warning signal would also be conceivable. If for example the automatic cycle is interrupted on the basis of an error message a siren signal could be produced with the motor/pump combination.

The use of two degrees of freedom like motor speed and pump adjustment affords a large number of possible ways of providing the same external delivery volume with different acoustic characteristics.

In addition the invention can also be used in conjunction with a fixed displacement pump although then only one degree of freedom is available (speed) and a change in the operating state would also always result in a change in the external delivery volume.

Protection is also claimed for a shaping machine having a hydraulic drive unit according to the invention.

Further advantages and details of the invention will be apparent from the Figures and the related specific description. In the Figures:

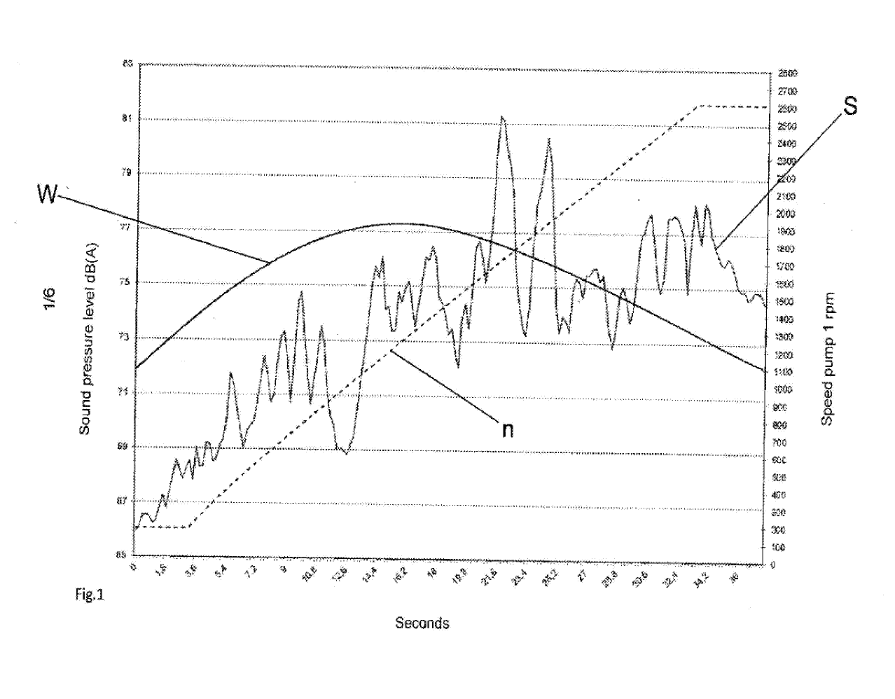

FIG. 1 shows the result of an investigation by the applicant, wherein the sound pressure level was measured in dependence on the pump speed,

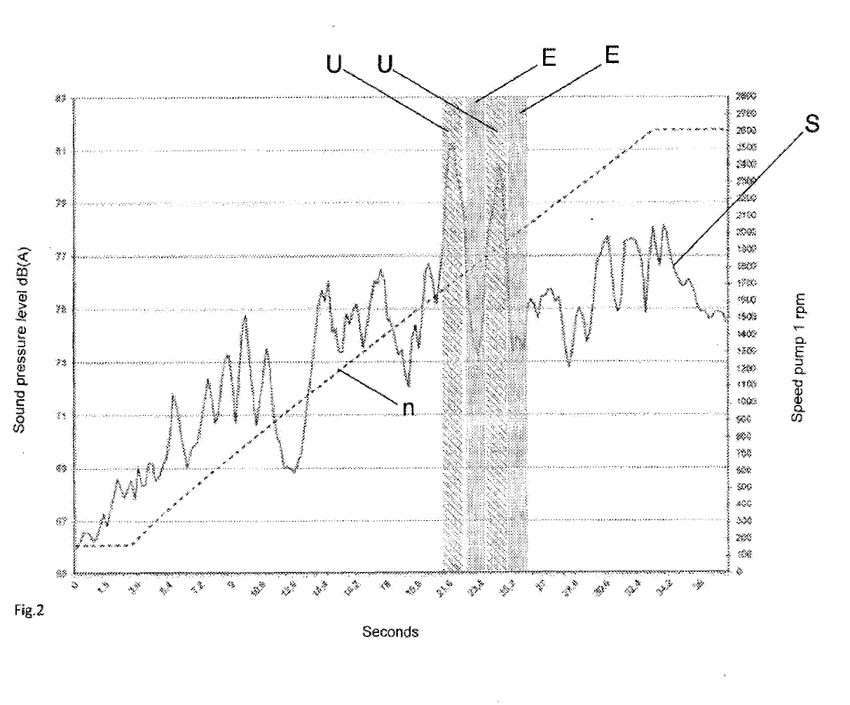

FIG. 2 shows the view from FIG. 1, with wanted and unwanted ranges additionally being shown,

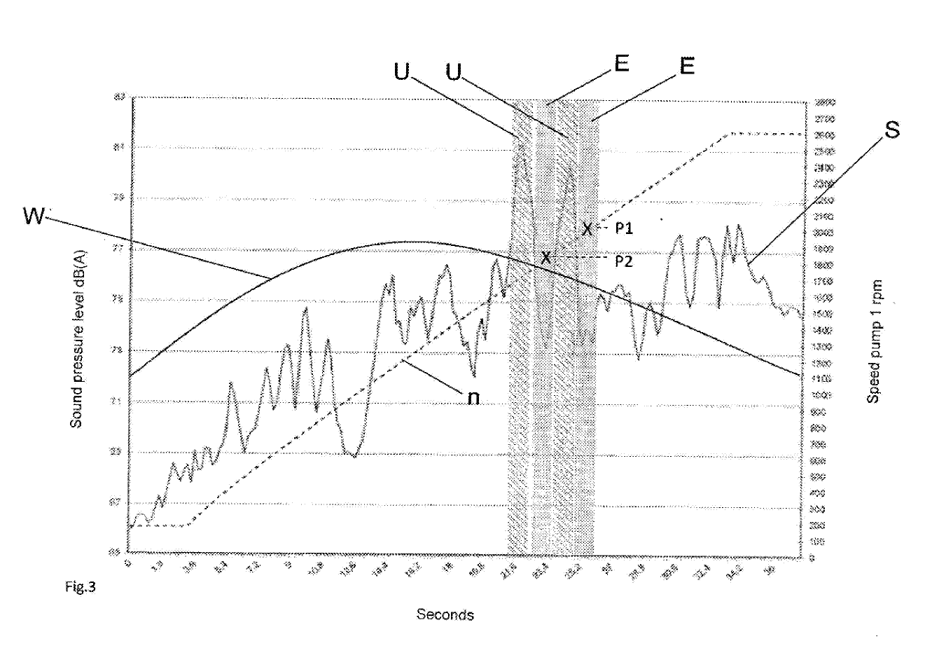

FIG. 3 shows the view from FIG. 2, with the efficiency of the drive unit additionally being shown,

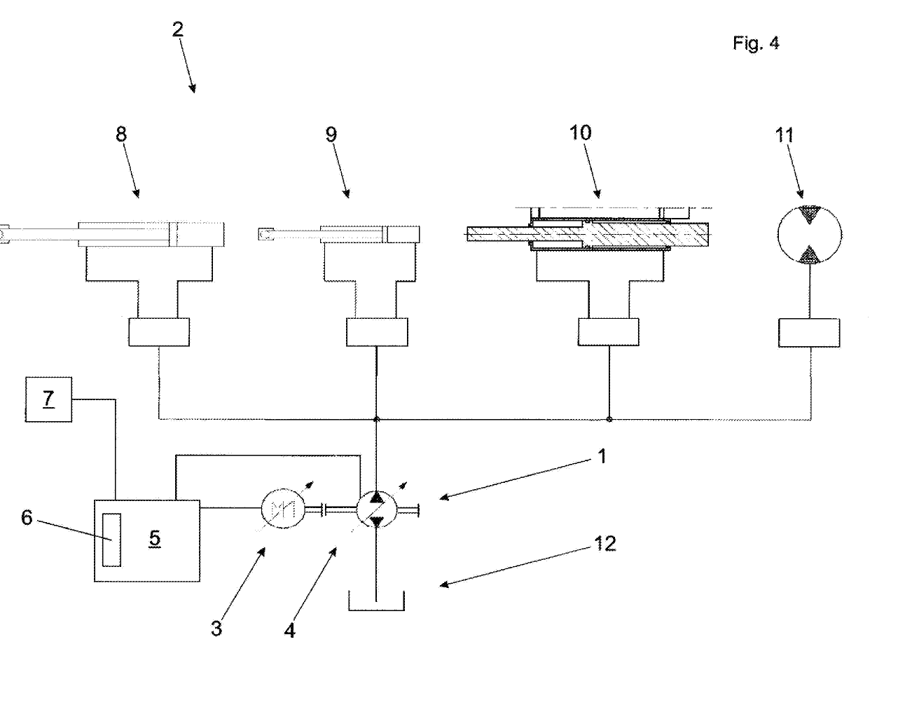

FIG. 4 shows a diagrammatic view of the drive unit together with supplied consumers of an injection molding machine,

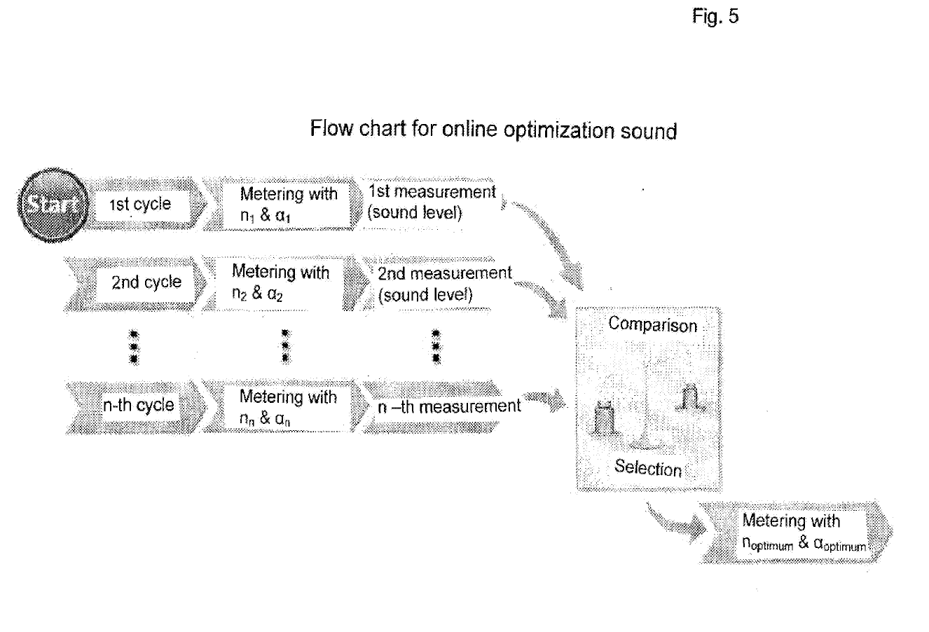

FIG. 5 shows a flow chart of a further embodiment of a method according to the invention, and

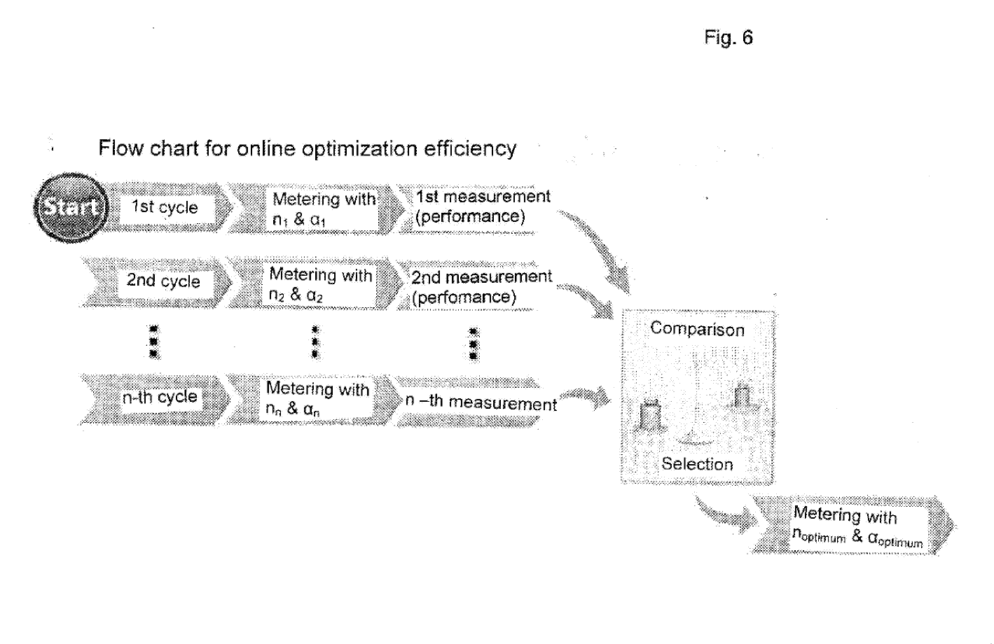

FIG. 6 shows a flow chart of an optional method for additional optimization of a level of efficiency.

FIG. 1 shows both a measured sound pressure level S and also the pump speed n plotted in each case in relation to time. In this case the speed was substantially linearly increased to produce a relationship between the sound pressure level S and the pump speed n.

As can be seen from FIG. 1 the monotonic relationship hitherto assumed to apply in the state of the art between volume (as mentioned the sound pressure S was used as the characteristic parameter) and the pump speed n does not hold true. Rather, marked minima and maxima occur due to interference and resonance effects. In particular it can be advantageous to slightly increase the speed at certain operating points in order to achieve a reduction in sound pressure.

In specific terms a motor/pump system in the pressure-holding mode at 200 bars was increased from 200 rpm to 2600 rpm and the sound pressure level of the overall system was measured. The sound pressure level peaks of (81 and 80 dBA) can be very clearly seen at around 1700 rpm and around 1900 rpm, which with an only slightly altered rotary speed of around 1800 rpm, are markedly lower (around 73 dBA). An optimum pump speed N can now be read from that graph. As an alternative firstly desired ranges E are established. That is shown in FIG. 2.

As an additional condition for the optimum pump speed n or the desired ranges E, it is also possible to use a minimum pump speed (if for example an external delivery amount which is at least to be maintained is to be achieved only by a given minimum speed). In the present example a minimum speed of 1600 rpm was adopted as the basic starting point. As can be easily seen from the Figure it is precisely not actuation of the minimum speed that is optimum as that provides for louder operation than an operating point within the desired ranges E. The corresponding ranges with high sound pressures were marked as unwanted ranges U.

It is additionally also possible to optimize the efficiency W. That is shown in FIG. 3 in which the efficiency W is shown additionally.

Two points P1 and P2 were also plotted, which are each in a separate desired range E. As however the point P2 offers a higher level of efficiency P than the point P1, the point P2 was in fact used as the operating point.

The data shown in FIG. 3 can be stored in a memory 6 of an open-loop or closed-loop control unit 5. It can also be provided that that relationship is modified by measurement values of a measuring device 7 for detecting for example the sound pressure (for example if the corresponding measurement value indicates a different sound pressure occurring with the respective pump speed n, than the sound pressure curve S in FIG. 3 does).

FIG. 4 shows a drive unit 1 according to the invention together with a diagrammatically illustrated shaping machine 2. Only components of the shaping machine 2 that are essential for the invention are shown. These would be a closing cylinder 8 for closing the closing unit, a pressurizing cylinder 9 for pressurizing an injection nozzle, an injection cylinder 10 for injecting an amount of plastic material and a hydraulic motor 11 for metering an amount of plastic material.

The drive unit 1 includes a motor 3 and a pump 4 which is driven by the motor 3 and which in this case is in the form of a pump 4 with a variable pump displacement α. Pressurized hydraulic fluid (preferably oil) is delivered from a tank 12 to the consumers by way of the pump 4.

The drive unit 1 also has an open-loop or closed-loop control unit 5 which provides for open-loop or closed-loop control both at the motor 3 and also the pump displacement α of the pump 4.

Besides the relationship between the sound pressure S and the pump speed n relationships between the sound pressure S and both the pump speed n and also the pump displacement α can naturally also be stored in the memory 6.

In this embodiment there is also a measuring device 7 for measuring the sound pressure 5.

FIG. 5 shows a flow chart for an alternative method according to the invention, which can be carried out during operation of the shaping machine 2. As in the various shaping cycles the respective metering method step is implemented with different pairs of values for the pump speed n₁ through nₙ and the pump displacement α₁ through αₙ. In addition the sound level S is measured in each shaping cycle. The open-loop or closed-loop control unit 5 can then extract the optimum value from the measurements and metering can thence be implemented with the optimum pump speed n and pump displacement α.

FIG. 6 shows a flow chart of an optional additional method wherein the efficiency of the drive unit 1 is also subjected to an optimization procedure.

In this case operation is as shown in FIG. 5, but here it is not an individual optimum pair of values that is output, but a quantity of acceptable pairs of values.

In addition in each shaping cycle the power consumed by the motor 3 and the delivery capacity of the pump 4 are measured. It is then possible to select from the pairs of values recognized as acceptable, a pair of values which is optimized both in respect of sound level S and also efficiency W, for the pump speed N and the pump displacement α.

Alternatively it is first possible to optimize the efficiency as shown in FIG. 6 and to optimize the sound level from pairs of values selected in that case, as shown in FIG. 5.

1. A hydraulic drive unit for a shaping machine comprising
a pump driven by a motor,
a closed-loop or open-loop control unit for closed-loop and/or open-loop control of the drive unit to a reference operating point of the drive unit, and
a memory connected to the closed-loop or open-loop control unit,
wherein a relationship between a parameter characteristic of a sound directly or indirectly caused by the drive unit and a data set representing various operating points of the drive unit is stored in the memory and the closed-loop or open-loop control unit is adapted to select the reference operating point based on the relationship.

2. A drive unit as set forth in claim 1 wherein there is provided closed-loop or open-loop control of the motor of a rotary speed.

3. A drive unit as set forth in claim 1 wherein the characteristic parameter is one or a combination of the following:
a sound pressure
a measure for a vibration of installation parts
a measure for pressure pulsations in hydraulic lines
inputs of an operator on the basis of volume perception

4. A drive unit as set forth in claim 1 wherein the operating points of the data set include at least one pump speed and/or pump displacement.

5. A drive unit as set forth in claim 1 wherein given operating points of the data set are marked as unwanted and the closed-loop or open-loop control unit is adapted not to use ranges of unwanted operating points as the reference operating point or to alter the reference operating point if it is in a range of unwanted operating points.

6. A drive unit as set forth in claim 1 wherein given operating points of the data set are marked as desired and the closed-loop or open-loop control unit is adapted to select reference operating points from ranges of desired operating points.

7. A drive unit as set forth in claim 1 wherein there is provided a measuring device for measurement of the characteristic parameter.

8. A drive unit as set forth in claim 7 wherein the open-loop or closed-loop control unit is adapted to adapt the relationship stored in the memory on the basis of measurement values of the measuring device, in particular during operation.

9. A drive unit as set forth in claim 2 wherein there is provided a closed-loop control means for the motor, wherein the closed-loop or open-loop control unit is adapted to use the characteristic parameter as a feedback parameter.

10. A drive unit as set forth in claim 1 wherein the closed-loop or open-loop control unit is adapted in selection of the reference operating point to take account of a minimum delivery capacity, a minimum volume flow to be delivered and/or a minimum pressure to be maintained.

11. A drive unit as set forth in claim 1 wherein the closed-loop or open-loop control unit is adapted in selection of the reference operating point to take account of an energy effectiveness, in particular a level of efficiency of the hydraulic drive unit.

12. A shaping machine comprising a hydraulic drive unit as set forth in claim 1.

13. A method of operating a hydraulic drive unit for a shaping machine, in particular as set forth in claim 1, wherein a pump is driven by means of a motor, wherein
a relationship is provided between a parameter characteristic of a sound directly or indirectly caused by the drive unit and a data set representing various operating points of the drive unit, and
based on the relationship an operating point of the drive unit is selected as a reference operating point for closed-loop and/or open-loop control of the drive unit.
